(19) United States
(12) Patent Application Publication
(10) Pub. No.: US 2007/0235673 A1
(43) Pub. Date: Oct. 11, 2007

(54) Microfluidic device with elastomeric seal

(75) Inventor: Dominick Danna, Syracuse, NY (US)

Correspondence Address: HISCOCK & BARCLAY, LLP, 2000 HSBC PLAZA, 100 Chestnut Street, ROCHESTER, NY, 14604-2404, US

(73) Assignee: Welch Allyn, Inc.

(21) Appl. No.: 11/401,739

(22) Filed: Apr. 11, 2006

(51) Int. Cl. F16L 29/00

(52) U.S. Cl. 251/149

(57) ABSTRACT

The invention comprises a low cost method of sealing and resealing a microfluidic device before, during, and after communication of fluids into the microfluidic device. The invention includes a microfluidic device with fluid introduction ports substantially hermetically sealed with elastomeric plugs, wherein the plugs can be penetrated by hollow needles to introduce fluids such as air, water, ethanol, or other chemical or biological reagents into the device while maintaining a substantially hermetic seal. The invention includes a method for introducing fluids into a microfluidic device from an external source. The method comprises the steps of penetrating fluid introduction ports substantially hermetically sealed with elastomeric plugs with hollow needles connected to a fluid source, pumping fluid into the device, and removing the hollow needle from the plug, whereupon plug self-reseals to form a substantially hermetic seal.

### FIELD OF THE INVENTION

This invention relates to microfluidic devices, and more particularly, to a device and method for communicating fluids and reagents to a disposable diagnostic microfluidic device while ensuring a substantially hermetic seal.

### BACKGROUND OF THE INVENTION

Microfluidic devices are used to perform a variety of analytical testing. Biological, chemical, or clinical samples are routinely analyzed using disposable diagnostic microfluidic devices. Microfluidic devices generally consist of a substrate which is constructed in a multi-layer laminated, plastic, or elastic structure, where each layer has channels fabricated to form microscale voids or channels for fluid flow. This is accomplished by photolithography, wet chemical etching, or other techniques known in the art. An example of a point-of-care diagnostic microfluidic device is disclosed in U.S. patent application Ser. Nos. 10/981,369 and 11/267,647, which are hereby incorporated by reference.

A microscale channel is a fluid passage wherein fluid control is affected by either external pressurized fluid forced into the channels, or by structures within the device. The synthetic and analytical capabilities of microfluidic devices are generally enhanced by increasing the number and complexity of network channels, reaction chambers, etc. A microscale channel is generally defined as a fluid passage that has at least one internal cross-sectional dimension that is less than 500 μm and is typically between 0.1 μm and about 500 μm.

The structures and methods used to introduce samples and other fluids into microfluidic channels can limit their capabilities. The microfluidic devices must frequently interact with external devices or assemblies external to the microfluidic device. For example, a microfluidic device may require a connection to a larger fluid source or integration with a pump or other external assembly. Fluid introduction ports (e.g., fluid inlets or orifices) provide an interface between the surrounding world and the microfluidic channel network. Methods and techniques limiting contamination of the microfluidic channels, and exposure of the microfluidic fluids to users and patients are currently inadequate.

One approach to this integration problem involves securing discrete, functional components, such as flow connectors, to a microfluidic device using an adhesive, as discussed by United States Patent Application Publication Number 2005/0151371A1, issued to Simmons, et al. This technique is subject to leakage between the microfluidic device and external components. Moreover, alignment errors may occur as each component is independently adhered to the microfluidic device. Simmons et. al teaches a method of injection molding to form microfluidic devices with integrated functional components. This technique, however, does not allow for the introduction of fluids into the microfluidic device from external sources, where the sources remain external to the microfluidic device at all times.

Therefore, a device and method for communicating fluids and reagents to microfluidic device while insuring a substantially hermetic seal is desired.

Further, a microfluidic device that is sealed substantially hermetically with all contents remaining internal to the microfluidic device after use that also produces no contamination or exposure of the contents to users and patients is desired.

### SUMMARY OF THE INVENTION

The invention comprises, in one form thereof, a low cost method of substantially hermetically sealing and resealing a microfluidic device before, during, and after communication of fluids into the microfluidic device.

More particularly, the invention includes a microfluidic device with fluid introduction ports substantially hermetically sealed with elastomeric plugs, wherein the plugs can be penetrated by hollow needles to introduce fluids such as air, water, ethanol, or other chemical or biological reagents into the device while maintaining a substantially hermetic seal.

In another form, the invention includes a method for introducing fluids into a microfluidic device from an external source. The method comprises the steps of penetrating fluid introduction ports substantially hermetically sealed with elastomeric plugs with hollow needles connected to an external fluid source, pumping fluid into the microfluidic device, removing the hollow needle from the plug, and resealing the plug to produce a substantially hermetic seal.

An advantage of the present invention is that fluids and reagents may be communicated to the microfluidic device while maintaining a substantially hermetic seal.

A further advantage of the present invention is that fluids such as ethanol, water, air, or other chemical or biological reagents, may be communicated to the microfluidic device from a source remains at all times external to the microfluidic device.

An even further advantage of the present invention is that the microfluidic device retains its contents and produces substantially no contamination or exposure to patients or users. Another advantage is that the elastomeric plugs need very little space on the microfluidic device and therefore can be located on the microfluidic device's edge.

### BRIEF DESCRIPTION OF THE DRAWINGS

The present invention is disclosed with reference to the accompanying drawings, wherein:

FIG. 1 is a top perspective view of a microfluidic device according to the present invention;

FIG. 2 is a top perspective view of an external source of fluid container communicating water, ethanol, and air into the microfluidic device according the present invention;

FIG. 3 is a side perspective view of a microfluidic device according to the present invention.

Corresponding reference characters indicate corresponding parts throughout the several views. The example set out herein illustrates one embodiment of the invention but should not be construed as limiting the scope of the invention in any manner.

### DETAILED DESCRIPTION

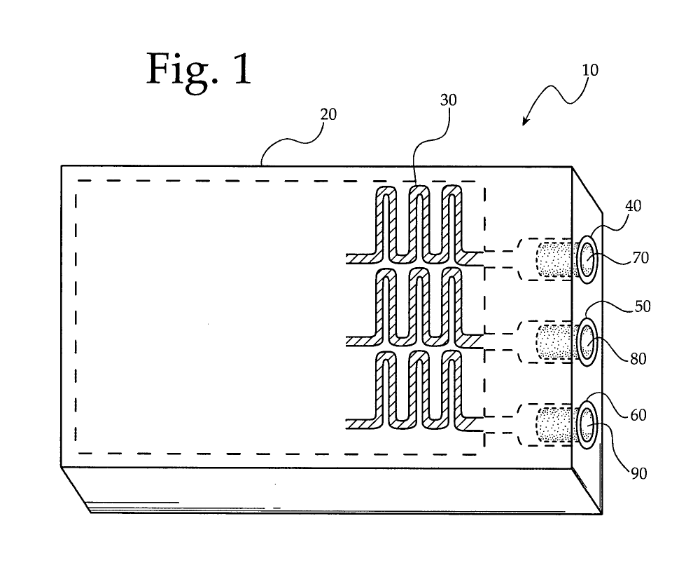

Referring to FIG. 1, there is shown the microfluidic device of the present invention. The microfluidic device 10 comprises a body structure 20 comprising a substrate. In this embodiment, the microfluidic device is in the form of a self-contained card-like point-of-care diagnostic device, which is well known in the art. At least one microfluidic channel 30 is disposed within said substrate. As discussed above, the term microfluidic channel generally refers to a solution flow path into which samples can be introduced and transported. In one embodiment the microfluidic channel may form a loop for continuous and cyclic solution flow through the channel. Other embodiments may comprise a plurality of intersecting channels to form an array or matrix of chambers or junctions at which reactions can occur. It is also contemplated the microfluidic device may contain various other components common to microfluidic devices, such as multiple flow channels, control channels, valves and/or pumps (not shown).

Fluid introduction ports 40, 50, and 60 are disposed on the surface of said body structure 20. The fluid introduction ports 40, 50, and 60 are in fluid communication with at least one microfluidic channel 30 at one end, and are exposed to the environment outside the microfluidic device on the other. In one embodiment, a collar may be molded on the microfluidic device at the portion of each fluid introduction port exposed to the environment, as seen in FIGS. 1, 2, and 3. The introduction ports 40, 50, and 60 are substantially hermetically sealed with elastomeric plugs 70, 80, and 90. In one embodiment, the said collar captures and holds said elastomeric plugs. The term “elastomer” and “elastomeric” has its general meaning as used in the art, e.g., as polymers existing at a temperature between their glass transition temperature and liquefaction temperature. Elastomeric materials exhibit elastic properties because the polymer chains readily undergo torsional motion to permit uncoiling of the backbone chains in response to a force, with the backbone chains recoiling to assume the prior shape in the absence of the force. Elastomers deform when force is applied, but then return to their original shape when the force is removed. Elastomeric plugs 70, 80, and 90 are penetrable by a fluid transmission means.

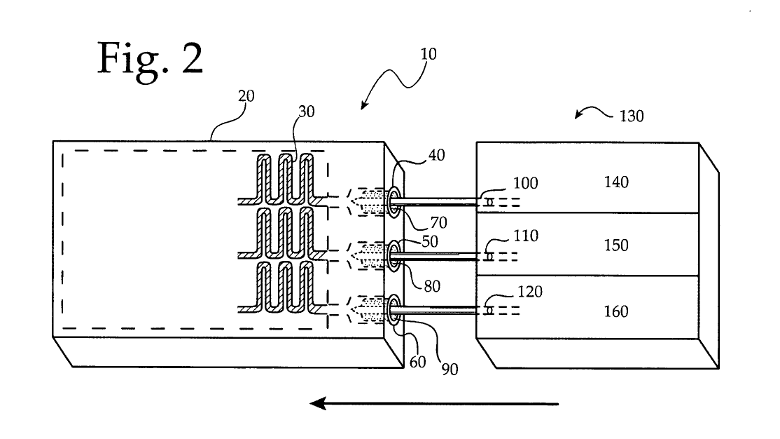

Referring to FIG. 2, fluid transmission means are shown as hollow needles 100, 110, and 120. Other fluid transmission means such as laboratory pipettes may be employed. The fluid transmission means 100, 110, and 120 are in fluid communication with an fluid source 130 located external to the microfluidic device 10. The external fluid source 130 may contain reservoirs for storing fluids such as ethanol 140 or water 150, or may be comprised of an air pump 160. Fluids are communicated from the external fluid source 130 to the microfluidic device 10 by penetrating at least one fluid introduction port 40, 50, or 60 of the microfluidic device 10 with at least one fluid communication means 100, 110, or 120. In this embodiment, communication is accomplished by causing the hollow needles 100, 110, and 120 to penetrate the elastomeric plugs 70, 80, and 90, and transmiting fluid from the external fluid source 130 through the fluid introduction ports 40, 50, and 60 to the microfluidic channel 30 disposed inside the microfluidic device 10. The elastomeric plugs 70, 80, and 90 maintain substantially hermetic seals before, during, and after penetration by the needles 100, 110, and 120. The needles 100, 110, and 120 are then removed from contact with the elastomeric plugs 70, 80, and 90. The elastomeric plugs 70, 80, and 90 self-reseal to form a substantially hermetic seal following penetration.

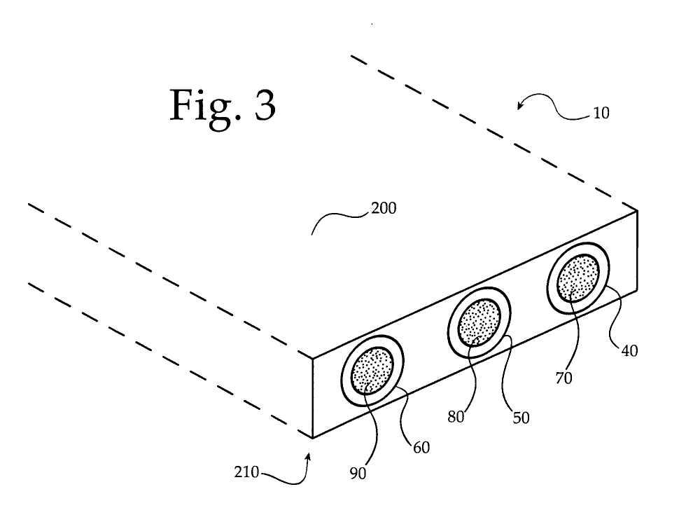

Referring now to FIG. 3, a raised side perspective view of the microfluidic device of the present invention is shown. The microfluidic device 10 is comprised of an upper surface 200 and a lower surface 210 connected by an edge. In this embodiment, fluid introduction ports 40, 50, and 60 are disposed in this edge, however, they may be disposed on any surface of the microfluidic device 10 as needed. Fluid introduction ports 40, 50, and 60 are substantially hermetically sealed by elastomeric plugs 70, 80, and 90. Elastomeric plugs 70, 80, and 90 are sized such that a substantially hermetic seal is maintained at all times in fluid introduction ports 40, 50, and 60. The elastomeric plugs prevent leakage and exposure to users and patients by containing all solutions and samples communicated to the device and concurrently prevent contamination of the device's contents by external contaminants.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A microfluidic device comprising:
a body structure comprising a substrate;
at least one microfluidic channel disposed within said substrate; and
a fluid introduction port on a surface of said body structure;
wherein said introduction port is substantially hermetically sealed with an elastomeric plug.

2. The microfluidic device of claim 1 wherein said fluid introduction port is in fluid communication with at least one microfluidic channel.

3. The microfluidic device of claim 1 wherein said elastomeric plug is penetrable by a fluid transmission means.

4. The microfluidic device of claim 3 wherein said fluid transmission means is a hollow needle.

5. The microfluidic device of claim 3 wherein said fluid transmission means is in fluid communication with a fluid source.

6. The microfluidic device of claim 5 wherein said fluid source contains a fluid chosen from the group consisting of air, ethanol, and water.

7. The microfluidic device of claim 3 wherein said elastomeric plug maintains said substantially hermetic seal before, during, and after penetration by said fluid transmission means.

8. The microfluidic device of claim 3 wherein said elastomeric plug self-reseals to form a substantially hermetic seal following penetration and removal by said fluid transmission means.

9. A method for communicating fluid to a microfluidic device comrprising the steps of:
penetrating a fluid introduction port of a microfluidic device with a fluid transmission means,
transmitting a fluid from a fluid source through said fluid transmission means; and
removing said fluid transmission means from said fluid introduction port, whereupon said elastomeric plug self-reseals to form a substantially hermetic seal.

10. The method of claim 9 wherein said fluid transmission means is a hollow needle.

11. The method of claim 9 wherein said fluid is chosen from the group consisting of air, ethanol, and water.

12. A microfluidic device comprising:
a body structure comprising a substrate;
multiple microfluidic channels disposed within said substrate; and
multiple fluid introduction ports on a surface of said body structure;
wherein said introduction ports are substantially hermetically sealed with elastomeric plugs.
